(19) United States
(12) Patent Application Publication
(10) Pub. No.: US 2007/0040935 A1
(43) Pub. Date: Feb. 22, 2007

(54) Apparatus for converting image signal and a method thereof

(75) Inventors: Young-ho Lee, Yongin-si (KR); Seung-joon Yang, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/376,334

(22) Filed: Mar. 16, 2006

(30) Foreign Application Priority Data
Aug. 17, 2005 (KR) 10-2005-0075443

(51) Int. Cl. H04N 7/01

(52) U.S. Cl. 348/452

(57) ABSTRACT

An apparatus for converting an image signal includes a motion estimation unit which estimates a motion vector using current and reference fields; a ticker region detection unit which detects a ticker region of an image using the estimated motion vector where an image moving with a constant speed and direction in a current field is found; a motion information analysis unit which determines whether or not there exists an image moving with a constant speed and direction in the ticker region based on the frequency of a motion vector estimated within the detected ticker region; and an interpolation unit which interpolates the current field by controlling a degree of temporal and spatial interpolations using an output of the motion information analysis unit. Accordingly, interpolation is differently applied in accordance with characters and graphics moving with a constant speed and direction in an input image, so that picture quality can be enhanced.

This application claims priority under 35 U.S.C. § 119 from Korean Patent Application No. 10-2005-0075443, filed on Aug. 17, 2005, the entire content of which is incorporated herein by reference.

### BACKGROUND OF THE INVENTION

1. Field of the Invention

Apparatuses and methods consistent with the present invention relate to converting an image signal and a method thereof, and more particularly to an apparatus for converting an image signal and a method thereof, which detect texts and graphics being contained in an image signal and moving in a fixed direction, and implement interpolation based thereon.

2. Description of the Related Art

An interlace scan mode and a progressive scan mode are provided as scan modes of an image display apparatus. The interlace scan mode is used for general TVs and the like. The interlace scan mode is a mode that, when one image is displayed, divides one image frame into two fields and sequentially and alternately displays the fields on a screen to form an image. At this time, the two fields are referred to as a top field and a bottom field, an upper field and a lower field, an odd field and an even field, or the like.

On the other hand, the progressive scan mode is used for computer monitors, digital TVs, and so on. The progressive scan mode is a mode that treats one frame image as a frame unit and displays full frame images at one time as is done when projecting a film on the screen.

Video display devices using the progressive scan mode are increasing in number, and, at the same time, there is required a de-interlacing technique to convert the interlace scan mode into the progressive scan mode.

In the de-interlacing technique for converting an image signal of the interlace scan mode into that of the progressive scan mode, there has mainly been used a method for switching intra-field interpolation pixels to inter-field interpolation pixels using motion information or image format conversion information.

Here, the intra-field interpolation is a method of implementing a new field by inserting an average data of two line data between two lines of a current field, and the inter-field interpolation is a method of inserting data using data before and after a current field between current field lines.

In the meantime, in TVs, information separate from images is transmitted through a ticker moving characters or graphics with a constant speed and direction. Since such information is displayed on an image having an abrupt variation of gray levels and moving at a constant speed, a user is sensitive to resolution.

To prevent image quality deterioration due to motion estimation errors, a format conversion apparatus such as a de-interlacing apparatus tends to reduce uses of a large number of inter-field interpolation pixels for interpolating with fields before and after a current field. As a result, there is a disadvantage in that the picture quality of characters and graphics moving at a constant speed is deteriorated due to uses of the intra-field interpolation pixels for characters and graphics moving at a constant speed. That is, the de-interlacing method can have an effect on the readability of characters moving with a constant speed and direction in accordance with an interpolation method and its performance.

### SUMMARY OF THE INVENTION

The present invention has been developed in order to address the above and other problems associated with the related art. An aspect of the present invention is to provide an apparatus for converting an image signal and a method thereof, wherein interpolation is differently applied in accordance with characters and graphics moving with a constant speed and direction in an input image, so that picture quality can be enhanced.

In order to achieve the above aspect of the present invention, there is provided an apparatus for converting an image signal according to an exemplary embodiment of the present invention, including a motion estimation unit which estimates a motion vector using a current field and a reference field; a ticker region detection unit which detects a ticker region of an image using the estimated motion vector, wherein the ticker region comprises the image moving with a constant speed and direction in the current field; a motion information analysis unit which determines whether or not there exists an image moving with a constant speed and direction in the ticker region based on a frequency of a motion vector estimated within the detected ticker region; and an interpolation unit which interpolates the current field by controlling a degree of temporal interpolation and spatial interpolation using an output of the motion information analysis unit.

Preferably, but not necessarily, the motion information analysis unit includes a histogram generation unit which generates a histogram using the motion vector estimated within the ticker region; a retrieval unit which retrieves a motion vector having a highest frequency in the histogram; and a discrimination unit which determines whether or not the ticker region contains the image moving with a constant speed and direction using the number of motion vectors estimated within the ticker region and the highest frequency.

Also, preferably, but not necessarily, the motion information analysis unit further includes an analysis unit which analyzes whether or not a corresponding ticker region detected from a previous field input previously contains an image moving with a constant speed and direction; and a determination unit which determines, using each output of the discrimination unit and analysis unit, that the current field has the ticker region containing the image moving with a constant speed and direction in the case that the ticker region of the current field contains the image moving with a constant speed and direction and the corresponding ticker region of the previous field contains an image moving with a constant speed and direction.

It is preferred, but not necessary, that the discrimination unit determines that there exists the image moving with a constant speed and direction in the ticker region in the case that a value generated by dividing the highest frequency by the number of motion vectors estimated within the ticker region is larger than a predetermined value.

Preferably, but not necessarily, the interpolation unit includes a spatial interpolator which interpolates the current field using pixel data within the current field; a temporal interpolator which interpolates the current field using a previous field consecutively input before the current field, a next field consecutively input after the current field, and the motion vector; a weight generator which generates at least one weight applied to at least one of the spatial and temporal interpolators in accordance with whether or not there exists the image moving with a constant speed and direction in the ticker region; and an adder which adds each output of the spatial interpolator and the temporal interpolator, and then generates an output image.

According to another aspect of the present invention, there is provided a method of converting an image signal according to an exemplary embodiment of the present invention, including estimating a motion vector using a current field and a reference field; detecting a ticker region of an image using the estimated motion vector, wherein the ticker region comprises an image moving with a constant speed and direction in the current field; determining whether or not there exists an image moving with a constant speed and direction in the ticker region using a frequency of a motion vector estimated within the ticker region; and interpolating the current field, by controlling a degree of temporal interpolation and spatial interpolation using an output of the discrimination.

Preferably, but not necessarily, the determining whether or not there exists the image moving with a constant speed and direction in the ticker region includes generating a histogram using the motion vector estimated within the ticker region; retrieving a motion vector having a highest frequency in the histogram; and determining whether or not the ticker region contains the image moving with a constant speed and direction using the retrieved motion vector having the highest frequency in the histogram.

Also, preferably, but not necessarily, the determining whether or not there exists the image moving with a constant speed and direction in the ticker region further includes analyzing whether or not a corresponding ticker region detected from a previous field input previously contains an image moving with a constant speed and direction; and determining that the current field has the ticker region containing the image moving with a constant speed and direction in the case that the ticker region of the current field contains the image moving with a constant speed and direction and the corresponding ticker region of the previous field contains an image moving with a constant speed and direction.

Preferably, but not necessarily, it is determined that there exists the image moving with a constant speed and direction in the ticker region in the case that a value generated by dividing the highest frequency by the number of motion vectors estimated within the ticker region is larger than a predetermined value.

Preferably, but not necessarily, the interpolating includes performing spatial interpolation the current field using pixel data within the current field; performing temporal interpolation of the current field using a previous field consecutively input before the current field, a next field consecutively input after the current field and the motion vector; generating at least one weight applied to at least one of the performing of the spatial and temporal interpolations in accordance with whether or not there exists an image moving with a constant speed and direction; and adding each output of the performing of the spatial interpolation and the temporal interpolation, and then generating an output image.

### BRIEF DESCRIPTION OF THE DRAWINGS

The above aspects and features of the present invention will be more apparent by describing certain exemplary embodiments of the present invention with reference to the accompanying drawings, in which:

FIG. 1 is a block diagram illustrating an apparatus for converting an image signal according to one exemplary embodiment of the present invention;

FIG. 2 is an exemplary block diagram illustrating an operation of a motion information analysis unit of FIG. 1;

FIG. 3 is an exemplary block diagram illustrating an operation of a interpolation unit of FIG. 1;

FIG. 4 is flowchart illustrating a method of converting an image signal according to one exemplary embodiment of the present invention; and

FIGS. 5A to 5C are exemplary views illustrating the motion estimation and ticker region detection of FIG. 4.

### DETAILED DESCRIPTION OF THE EXEMPLARY EMBODIMENTS

Certain exemplary embodiments of the present invention will be described in greater detail with reference to the accompanying drawings.

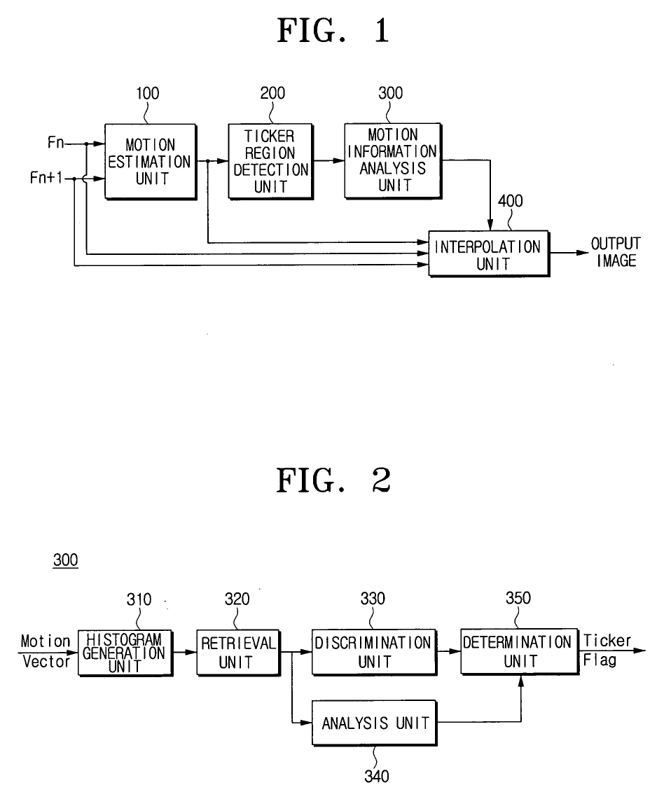

FIG. 1 is a block diagram illustrating an apparatus for converting an image signal according to one exemplary embodiment of the present invention.

Referring to FIG. 1, the apparatus for converting an image signal of the present invention includes a motion estimation unit 100, a ticker region detection unit 200, a motion information analysis unit 300 and an interpolation unit 400.

First, the motion estimator unit 100 estimates a motion vector indicating a direction and magnitude of motion using a current field and a reference field. At this time, the reference field can be a previous field consecutively input before the current field or a next field consecutively input after the current field. Also, motion estimation can be calculated by calculating motion vectors not only between temporally consecutive fields but also between frames.

Further, the motion estimation unit 100 can implement motion estimation using various motion estimation algorithms such as BMA (Block Matching Algorithm), phase correlation and a hierarchical search BMA (HSBMA).

The ticker region detection unit 200 detects a ticker region within a current field using a motion vector estimated from the motion estimation unit 100. Here, the ticker region refers to a region of an image moving with a constant speed and direction. In the case that the estimated motion vector is fixed in a specific region, the specific region is detected as the ticker region. At this time, since the ticker region is mainly located in the upper or lower region of a screen, the ticker region can be preset by a user.

The motion information analysis unit 300 discriminates whether or not an image moving with a constant speed and direction exists within the ticker region detected from the ticker region detection unit 200 based on the frequency of a motion vector within a region detected as the ticker region in an input signal.

FIG. 2 is an exemplary block diagram illustrating an operation of the motion information analysis unit 300 of FIG. 1.

Referring to FIG. 2, the motion information analysis unit 300 includes a histogram generation unit 310, a retrieval unit 320, a discrimination unit 330, an analysis unit 340 and a determination unit 350.

The histogram generation unit 310 generates a histogram using a motion vector estimated from the motion estimation unit 100, and the retrieval unit 320 retrieves a motion vector having the highest frequency from the generated histogram.

The discrimination unit 330 determines whether or not there exists an image such as text or a graphic image moving with a constant speed and direction in the detected ticker region based on the highest frequency having the same motion vector in the detected ticker region. That is, the discrimination unit 330 tests the validity of whether or not a motion vector having the highest frequency can be a representative of the ticker determination. If a value generated by dividing the highest frequency by the number of motion vectors detected within the ticker region is larger than a predetermined value, it is determined that the ticker region has an image moving with a constant speed and direction.

The analysis unit 340 analyzes the history of a motion vector in previous fields temporally consecutively input before a current field. The analysis unit 340 analyzes information on whether or not there exists an image moving with a constant speed and direction in a ticker region detected from the previous fields, information on the location of the ticker region and the like.

The determination unit 350 determines whether or not there exists an image moving with a constant speed and direction in a ticker region finally detected using an output of the discrimination unit 330 and an output of the analysis unit 340. In the case that, as the determination result of the discrimination unit 330, it is determined that the ticker region detected in a current field contains an image moving with a constant speed and direction, and, as the analyzed result of the analysis unit 340, it is analyzed that the same ticker region detected in a previous field as in the current field also contains an image moving with a constant speed and direction, the determination unit 350 finally determines that the current field has a ticker region containing an image moving with a constant speed and direction.

In the meantime, the interpolation unit 400 implements interpolation of a current field using a result of the motion information analysis unit 300 and a motion vector detected from the motion estimation unit 100.

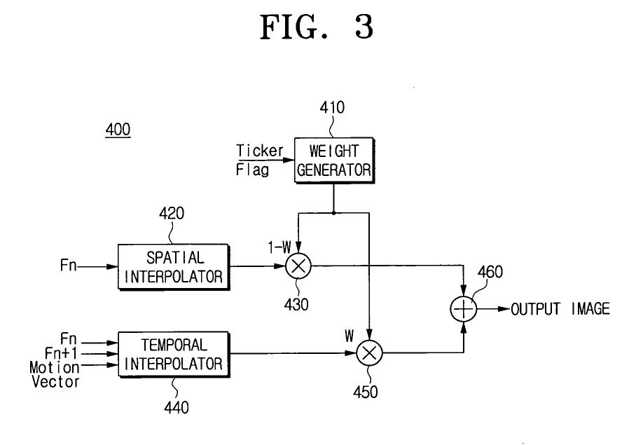

FIG. 3 is an exemplary block diagram illustrating an operation of an interpolation unit 400 of FIG. 1.

Referring to FIG. 3, the interpolation unit 400 includes a weight generator 410, a spatial interpolator 420, a temporal interpolator 440, a first multiplier 430, a second multiplier 450 and an adder 460.

The spatial interpolator 420 implements interpolation of a current field using pixel data within the current field. Also, the temporal interpolator 440 implements interpolation using a current field, pixel data of a consecutively input previous or next field of the current field, and a motion vector detected from the motion estimation unit 100.

The weight generator 410 generates weights applied to spatial and temporal interpolation using a result of the motion information analysis unit 300. In the case that it is determined that a current field has a ticker region containing an image moving with a constant speed and direction, the weights are generated such that a weight applied to the temporal interpolation is larger than a weight applied to the spatial interpolation.

On the other hand, in the case that it is determined by the motion information analysis unit 300 that a ticker region detected in a current field does not contain an image moving with a constant speed and direction, a weight is generated such that the weight applied to the spatial interpolation is larger than that applied to the temporal interpolation.

That is, in the case that it is determined that a current field has a ticker region containing an image moving with a constant speed and direction, the weight generator 410 determines a weight (w) to approximate “1”, and in the case that it is determined by the motion information analysis unit 300 that a ticker region detected in a current field does not contain an image moving with a constant speed and direction, the weight generator 410 determines the weight (w) to approximate “0”.

The first multiplier 430 multiplies a result of the spatial interpolator 420 by a weight (1-w) generated from the weight generator 410, and the second multiplier 450 multiplies a result of the temporal interpolator 440 by another weight (w) generated from the weight generator 410.

The adder 460 adds the result of the first multiplier 430 and the result of the second multiplier 450, and then output an output signal.

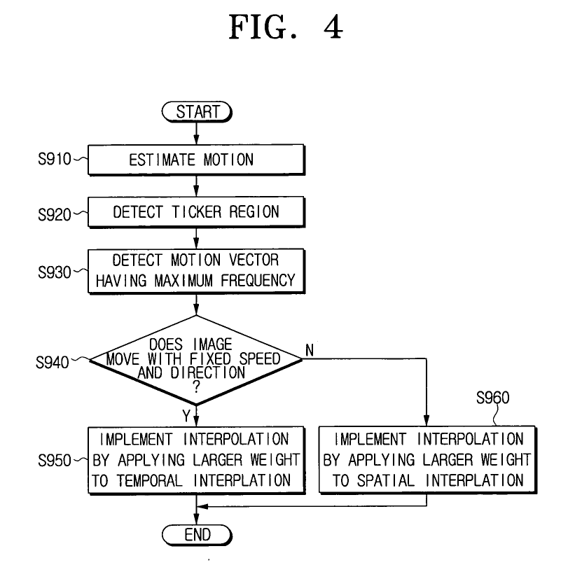

FIG. 4 is flowchart illustrating a method of converting an image signal according to one exemplary embodiment of the present invention.

Referring to FIG. 4, a motion of a current field is firstly estimated using the current field required to implement interpolation and a reference field (S910). Here, the reference field can be a previous field and a next field, which is temporally consecutively input with the current field. Further, the motion can be estimated using two consecutively input fields, i.e., two fields having parities different from each other. Furthermore, the motion between frames can be estimated using two fields having parities identical to each other. At this time, in the motion estimation, a motion vector can be detected using various motion estimation algorithms such as BMA (Block Matching Algorithm), phase correlation and HSBMA.

Subsequently, a ticker region is detected within the current field using the estimated motion (S920). The ticker region refers to a region of an image moving with a constant speed and direction. In the case that the estimated motion vector is fixed in a specific region, this specific region is detected as the ticker region.

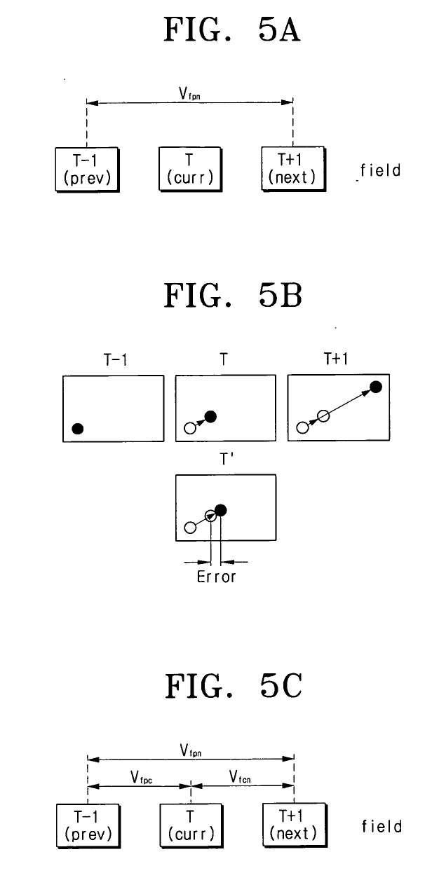

FIGS. 5A to 5C are exemplary views illustrating the motion estimation and ticker region detection of FIG. 4.

FIG. 5A is an exemplary view illustrating motion estimation between frames. Referring to FIG. 5A, the motion estimation between frames can be implemented by detecting a motion vector V_{fpn} between a previous field and a next field from three fields input temporally consecutively, i.e., the previous field T−1, the current field T and the next field T+1.

FIG. 5B is an exemplary view illustrating a motion vector detection error of a ticker region when estimating a motion between frames. If a motion vector between frames is fixed, but a motion vector between consecutive fields is not fixed, it is determined as a ticker region using motion estimation between frames.

That is, if a motion vector between frames is fixed, but a motion vector between consecutive fields is not fixed, as shown in FIG. 5A, only the motion vector between frames is detected, and if the motion vector between fields is not detected, there can be produced an error.

Referring to FIG. 5B, if a motion vector between frames is fixed, but a motion vector between consecutive fields is not fixed, a motion vector of a ticker region using the motion vector between frames is the same as a vector shown in the field T′. However, since the image of a current field is practically identical to the field T, there is produced such an error as shown in T′.

FIG. 5C is an exemplary view illustrating ticker region detection using motion estimation between frames, and motion estimation between fields.

Referring to FIG. 5C, if a ticker region is detected using motion estimation between frames, a motion vector between consecutive fields is used. If a motion vector between frames in a specific region is fixed, and also, a motion vector between consecutive fields in that specific region is fixed, i.e., if a half and the remaining half of the motion vector between frames are the motion vector between a current field and a previous field and the motion vector between a current field and a next field, respectively, that specific region of the current field is determined as a ticker region, thereby preventing a motion vector detection error of the ticker.

Subsequently, a histogram of a motion vector detected in the detected ticker region is generated, and a motion vector having the highest frequency is detected (S930).

Then, it is determined whether or not there exists an image moving with a constant speed and direction (S940). Using the motion vector having the highest frequency, it is determined whether or not there exists an image such as text or a graphic moving with a constant speed and direction in the detected ticker region.

To determine the presence of an image moving with a constant speed and direction, the validity is tested whether or not a motion vector having the highest frequency can be a representative of the ticker determination. If a value generated by dividing the highest frequency by the number of all the motion vectors detected within the ticker region is larger than a predetermined value, it is determined that the ticker region has an image moving with a constant speed and direction. This is because it is highly possible that there may be an image moving with a constant speed and direction in the ticker region in the case that there exist a large number of the same motion vectors within the detected ticker region.

Further, in the case that images moving with a constant speed and direction in the same ticker regions are detected even in previous fields input before a current field, an image moving with a constant speed and direction is highly possibly detected in a ticker region detected from the current field. Thus, the history of motion vectors of the previous fields temporally consecutively input before the current field is analyzed.

If it is determined that a ticker region detected from the current field contains an image moving with a constant speed and direction and that even previous fields contain images moving with a constant speed and direction in the same ticker region detected from the current field, it is finally determined that the current field has a ticker region containing an image moving with a constant speed and direction.

As a determined result of the step S940, in the case that the detected ticker region of the current field contains an image moving with a constant speed and direction, interpolation of the current field is implemented by applying a larger weight to temporal interpolation rather than to spatial interpolation (S950).

For an image moving with a constant speed and direction, temporal interpolation is implemented using a previous or next field of a current field rather than spatial interpolation implemented pixel data of the current field required to be interpolated, thereby minimizing an error produced in interpolation.

On the other hand, if the detected ticker region of the current field does not contain an image moving with a constant speed and direction, interpolation of the current field is implemented by applying a larger weight to spatial interpolation rather than to temporal interpolation (S960).

Therefore, an errorless output image can be output by adding results of temporal interpolation and spatial interpolation, to which each of the generated weights is applied in accordance with whether or not there exists an image moving with a constant speed and direction in the detected ticker region.

As described above, according to an exemplary embodiment of the present invention, an interpolation is differently applied in accordance with characters and graphics moving with a constant speed and direction in an input image, so that picture quality can be enhanced. In particular, in the case that there exist characters moving with a constant speed and direction in an input image, temporal interpolation is implemented for a region where characters exist rather than spatial interpolation, thereby enhancing the readability of characters.

The foregoing exemplary embodiments and advantages are merely exemplary and are not to be construed as limiting the present invention. The present teaching can be readily applied to other types of embodiments. Also, the description of the embodiments of the present invention is intended to be illustrative, and not to limit the scope of the claims, and many alternatives, modifications, and variations will be apparent to those skilled in the art.

What is claimed is:

1. An apparatus for converting an image signal, the apparatus comprising:
a motion estimation unit which estimates a motion vector using a current field and a reference field;
a ticker region detection unit which detects a ticker region of an image using the estimated motion vector, wherein the ticker region comprises an image moving with a constant speed and direction in the current field;
a motion information analysis unit which determines whether or not there exists an image moving with a constant speed and direction in a ticker region using a frequency of a motion vector estimated within the ticker region; and
an interpolation unit which interpolates the current field by controlling a degree of temporal interpolation and spatial interpolation using an output of the motion information analysis unit.

2. The apparatus according to claim 1, wherein the motion information analysis unit comprises:
a histogram generation unit which generates a histogram using the motion vector estimated within the ticker region;
a retrieval unit which retrieves a motion vector having a highest frequency in the histogram; and
a discrimination unit which determines whether or not the ticker region contains the image moving with a constant speed and direction using the retrieved motion vector having the highest frequency in the histogram.

3. The apparatus according to claim 2, wherein the discrimination unit is configured to use a number of motion vectors estimated within the ticker region and the highest frequency, in determining whether or not the ticker region contains the image moving with a constant speed and direction.

4. The apparatus according to claim 2, wherein the motion information analysis unit further comprises:
an analysis unit which analyzes whether or not a corresponding ticker region detected from a previous field input previously contains an image moving with a constant speed and direction; and
a determination unit which determines, using each output of the discrimination unit and analysis unit, that the current field has the ticker region containing the image moving with a constant speed and direction in the case that the ticker region of the current field contains the image moving with a constant speed and direction and the corresponding ticker region of the previous field contains an image moving with a constant speed and direction.

5. The apparatus according to claim 1, wherein the discrimination unit determines that there exists the image moving with a constant speed and direction in the ticker region in the case that a value generated by dividing the highest frequency by the number of motion vectors estimated within the ticker region is larger than a predetermined value.

6. The apparatus according to claim 1, whether the interpolation unit comprises:
a spatial interpolator which interpolates the current field using pixel data within the current field;
a temporal interpolator which interpolates the current field using a previous field consecutively input before the current field, a next field consecutively input after the current field, and the motion vector;
a weight generator which generates at least one weight applied to at least one of the spatial interpolator and the temporal interpolator in accordance with whether or not there exists the image moving with a constant speed and direction in the ticker region; and
an adder which adds each output of the spatial interpolator and the temporal interpolator, and then generates an output image.

7. The apparatus according to claim 6, wherein the weight generator is configured such that, if the motion information analysis unit determines that there exists the image moving with a constant speed and direction in the ticker region, a weight applied to the temporal interpolator is larger than a weight applied to the spatial interpolator.

8. The apparatus according to claim 7, wherein, if the weight applied to the temporal interpolator is w, the weight applied to the spatial interpolator is 1-w.

9. The apparatus according to claim 1:
wherein the motion estimation unit is further configured to estimate a motion vector using a current frame and a reference frame; and
wherein the ticker region detection unit is configured to use the motion vector, estimated using the current frame and the reference frame, in detecting the ticker region.

10. The apparatus according to claim 9, wherein the ticker region detection unit is further configured to determine a specific region of the current field as the ticker region, if the motion vector estimated using the current frame and the reference frame in the specific region is fixed, and also, a motion vector estimated using the current field and the reference field in the specific region is fixed.

11. The apparatus according to claim 9, wherein the ticker region detection unit is further configured to determine a specific region of the current field as the ticker region, if a half and the remaining half of the motion vector estimated using the current frame and the reference frame are a motion vector between the current field and a previous field and a motion vector between the current field and a next field, respectively.

12. An apparatus for converting an image signal, the apparatus comprising:
a motion estimation unit which estimates a motion vector using a current field and a reference field;
a motion information analysis unit which determines whether or not there exists an image moving with a constant speed and direction in a ticker region using a frequency of a motion vector estimated within the ticker region, wherein the ticker region is a predetermined region in a current field; and
an interpolation unit which interpolates the current field by controlling a degree of temporal interpolation and spatial interpolation using an output of the motion information analysis unit.

13. A method for converting an image signal, the method comprising:
estimating a motion vector using a current field and a reference field;
detecting a ticker region of an image using the estimated motion vector, wherein the region comprises an image moving with a constant speed and direction in the current field;
determining whether or not there exists an image moving with a constant speed and direction in the ticker region using a frequency of a motion vector estimated within the ticker region; and
interpolating the current field, by controlling a degree of temporal interpolation and spatial interpolation using an output of the discrimination.

14. The method according to claim 13, wherein the determining of whether or not there exists the image moving with a constant speed and direction in the ticker region comprises:
generating a histogram using the motion vector estimated within the ticker region;
retrieving a motion vector having a highest frequency in the histogram; and
determining whether or not the ticker region contains the image moving with a constant speed and direction using the retrieved motion vector having the highest frequency in the histogram.

15. The method according to claim 14, wherein the determining of whether or not there exists the image moving with a constant speed and direction in the ticker region further comprises:
analyzing whether or not a corresponding ticker region detected from a previous field input previously contains an image moving with a constant speed and direction; and
determining that the current field has the ticker region containing the image moving with a constant speed and direction in the case that the ticker region of the current field contains the image moving with a constant speed and direction and the corresponding ticker region of the previous field contains an image moving with a constant speed and direction.

16. The method according to claim 13, wherein it is determined that there exists the image moving with a constant speed and direction in the ticker region in the case that a value generated by dividing the highest frequency by the number of motion vectors estimated within the ticker region is larger than a predetermined value.

17. The method according to claim 13, wherein the interpolating comprises:
performing spatial interpolation by interpolating the current field using pixel data within the current field;
performing temporal interpolation by interpolating the current field using a previous field consecutively input before the current field, a next field consecutively input after the current field, and the motion vector;
generating at least one weight applied to at least one of the performing of the spatial interpolation and the temporal interpolation in accordance with whether or not there exists the image moving with a constant speed and direction in the ticker region; and
adding each output from the performing of the spatial interpolation and the temporal interpolation, and then generating an output image.

18. The method according to claim 17, wherein a weight applied to the performing of the temporal interpolation is larger than a weight applied to the performing of the spatial interpolator, if it is determined that there exists the image moving with a constant speed and direction in the ticker region.

19. The method according to claim 18, wherein weights applied to the performing of the temporal interpolation and the spatial interpolation are w and 1-w, respectively.

20. The method according to claim 13, further comprising:
estimating a motion vector using a current frame and a reference frame; and
using the motion vector, estimated using the current frame and the reference frame, in detecting the ticker region.

21. The method according to claim 20, further comprising determining a specific region of the current field as the ticker region, if the motion vector estimated using the current frame and the reference frame in the specific region is fixed, and also, a motion vector estimated using the current field and the reference field in the specific region is fixed.

22. The method according to claim 20, further comprising determining a specific region of the current field as the ticker region, if a half and the remaining half of the motion vector estimated using the current frame and the reference frame are a motion vector between the current field and a previous field and a motion vector between the current field and a next field, respectively.

23. A method for converting an image signal, the method comprising:
estimating a motion vector using a current field and a reference field;
predetermining a ticker region in the current field;
determining whether or not there exists an image moving with a constant speed and direction in the ticker region using a frequency of a motion vector estimated within the ticker region; and
interpolating the current field, by controlling a degree of temporal interpolation and spatial interpolation using an output of the discrimination.
